(19) United States
(12) Patent Application Publication
(10) Pub. No.: US 2012/0127134 A1
(43) Pub. Date: May 24, 2012

(54) PORTABLE COMPUTER

(75) Inventor: Kun-Hui LAI, TAIPEI CITY (TW)

(73) Assignee: INVENTEC CORPORATION, TAIPEI CITY (TW)

(21) Appl. No.: 12/981,511

(22) Filed: Dec. 30, 2010

(30) Foreign Application Priority Data
Nov. 23, 2010 (TW) 099222711

(51) Int. Cl. G09G 5/00

(52) U.S. Cl. 345/204

(57) ABSTRACT

A portable computer comprises a display housing, a first G-sensor, a main housing and a main board. A display is disposed inside the display housing. The first G-sensor is arranged in the display housing. The main housing is pivotally connected to the display housing. The main board has a processor and is arranged in the main housing. The main board is coupled to the first G-sensor and the display.

### RELATED APPLICATIONS

This application claims priority to Taiwan Application Serial Number 099222711, filed Nov. 23, 2010, which is herein incorporated by reference.

### BACKGROUND

1. Field of Invention

The present invention relates to a portable computer. More particularly, the present invention relates to a portable computer with a G-sensor.

2. Description of Related Art

The display and the main unit of a portable computer generally adopt a two-piece folding structure design. When the display is folded over the main unit, the display is turned off and even the portable computer is forced to enter a power saving mode, thereby saving the power consumed by the portable computer.

Currently, the method of detecting whether the display is folded over the main body is mainly to arrange a magnet and a sensor on the display and the main unit respectively. When the display approaches the main unit, the sensor senses a magnetic force of the magnet, thereby controlling the main unit to turn off the display and to enter a power saving mode.

However, when there is some other magnetic substance approaching the sensor, the sensor also senses a magnetic force and mistakenly decides that the display has approached the main unit, thus instructing the main unit to turn off the display. Such a misjudgment behavior often causes user inconvenience in using the portable computer.

Therefore, it is an important issue regarding how to improve the accuracy of discriminating whether the display of the portable computer is folded over the main unit the portable computer to judge, thereby enhancing operation convenience for the portable computer.

### SUMMARY

Accordingly, an aspect of the present invention is to provide a portable computer. The portable computer includes a display housing, a first G-sensor, a main housing and a main board. A display is disposed inside the display housing. The first G-sensor is arranged in the display housing. The main housing is pivotally connected to the display housing. The main board has a processor. The main board is arranged in the main housing and coupled to the first G-sensor and the display.

According to an embodiment of the present invention, when the gravity direction sensed by the first G-sensor senses is about 80° to 100° with respect to the horizontal plane (i.e. the gravity direction and the horizontal plane form an angle of about 80° to 100°), the processor turns off the display, and controls the portable computer to enter a power saving mode.

According to another embodiment of the present invention, the portable computer further includes a second G-sensor. The second G-sensor is arranged in the main housing and coupled to the main board. When the gravity direction sensed by the first G-sensor and the gravity direction sensed by the second G-sensor are substantially the same, e.g. when the difference between the gravity directions is about 0° to 20° (i.e. the gravity directions form an angle of about 0° to 20°), the processor turns off the display, and controls the portable computer to enter a power saving mode. When the gravity direction sensed by the first G-sensor and the gravity direction sensed by the second G-sensor are substantially opposite to each other, e.g. when the difference between the gravity directions is 160° to 180°, the processor switches the portable computer to a specific operation mode.

Another aspect of the present invention provides a portable computer having a display housing, a first G-sensor, a main housing, a second G-sensor and a main board. A display is disposed inside the display housing. The first G-sensor is arranged in the display housing. The main housing is pivotally connected to the display housing. The second G-sensor is arranged in the main housing. The main board has a processor and is arranged in the main housing. The main board is coupled to the first G-sensor, the second G-sensor and the display.

When the difference between the normal vector of the display surface of the display housing detected by the first G-sensor and the normal vector of the bottom surface of the main housing detected by the second G-sensor is about 0° to 20°, the processor turns off the display, and controls the portable computer to enter a first operation mode. When the difference between the normal vector of the display surface of the display housing detected by the first G-sensor and the normal vector of the bottom surface of the main housing detected by the second G-sensor is about 160° to 180° apart, the processor switches the portable computer to a second operation mode.

When the normal vector of the display surface of the display housing detected by the first G-sensor and the normal vector of the bottom surface of the main housing detected by the second G-sensor are in the same directions, the processor turns off the display screen of the display, and controls the portable computer to enter a first operation mode.

When the normal vector of the display surface of the display housing detected by the first G-sensor and the normal vector of the bottom surface of the main housing detected by the second G-sensor are in opposite directions, the processor switches the portable computer to a second operation mode.

The present invention arranges a G-sensor in a portable computer for sensing a position of the display; judging whether the display is folded over the main unit; and determining whether to dim the display to enter a power saving mode. As such, the G-sensor can be prevented from mistakenly considering that the display has been folded over the main unit for turning off the display due to some other magnetic substance as shown in a conventional design, thereby improving the accuracy of discriminating whether the display is folded over the main unit, and enhancing operation convenience for the portable computer.

### BRIEF DESCRIPTION OF THE DRAWINGS

The following objectives, features, advantages and embodiments of the present invention can be more fully understood, with reference made to the accompanying drawings as follows:

FIG. 1A is a schematic view of a portable computer according to an embodiment of the present invention;

FIG. 1B is a system architecture view of a portable computer according to an embodiment of the present invention;

FIG. 1C is a system control flow chart for a portable computer according to an embodiment of the present invention;

FIG. 2A is a schematic view of a portable computer according to another embodiment of the present invention;

FIG. 2B is a system architecture view of a portable computer according to another embodiment of the present invention;

FIG. 2C is a system control flow chart for a portable computer according to another embodiment of the present invention;

FIG. 3A is a schematic view of a portable computer according to yet another embodiment of the present invention; and

FIG. 3B is a system control flow chart for a portable computer according to yet another embodiment of the present invention.

### DETAILED DESCRIPTION

The embodiments of the present invention arrange a G-sensor in a portable computer. Through a signal detected by the G-sensor, it can be determined whether the display is folded over the main unit, thereby determining whether to enter a sleep mode or another operation mode.

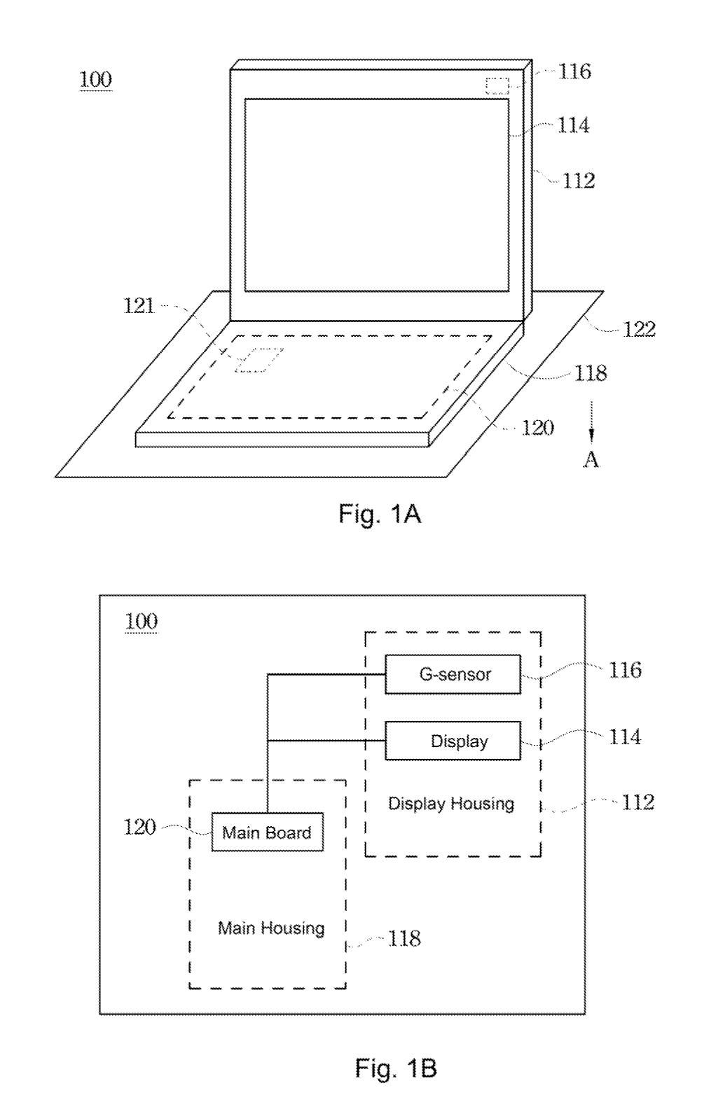

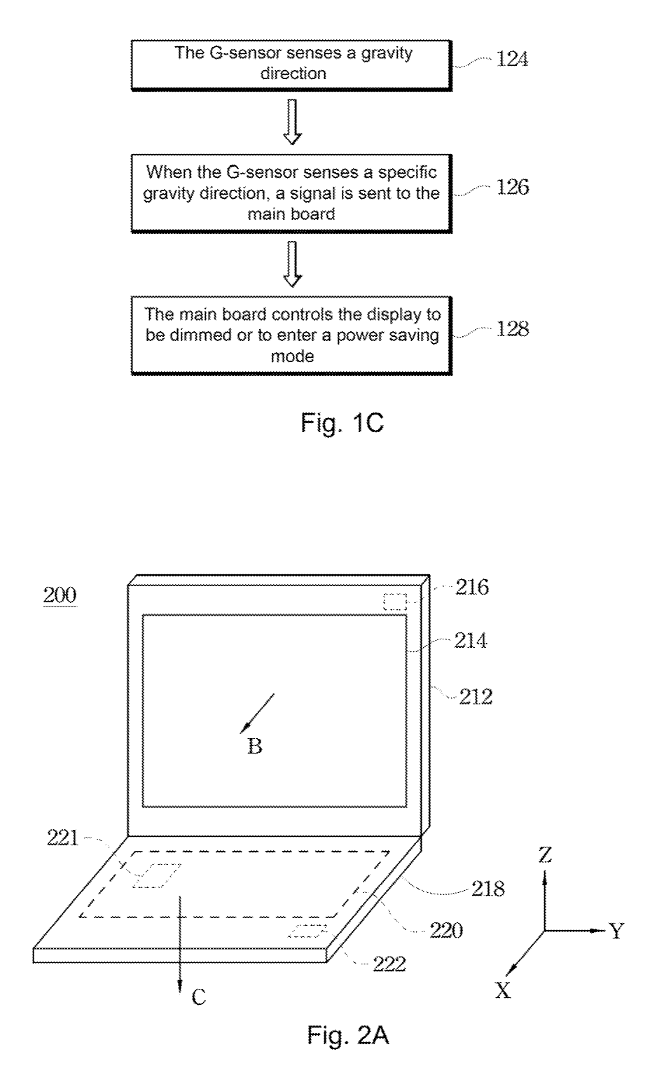

Referring to both FIG. 1A and FIG. 1B, FIG. 1A is a schematic view of a portable computer according to an embodiment of the present invention, and FIG. 1B is a system architecture view of a portable computer according to an embodiment of the present invention.

The portable computer 100 may comprise a display housing 112, a G-sensor 116, a main housing 118 and a main board 120. A display 114 is disposed inside the display housing 112. The G-sensor 116 is arranged in the display housing 112. Moreover, the main housing 118 is pivotally connected to the display housing 112, and thus the display housing 112 can be folded down to cover the main housing 118 so as to protect the display surface of the display 114; or the display housing 112 can be approximately perpendicular to the main housing 118 for a user to use the portable computer 100 conveniently. A processor 121 is arranged on the main board 120. The main board 120 is arranged in the main housing 118, and is coupled to the G-sensor 116 and the display 114. The main housing 118 and internal elements therein compose the main unit.

Since the G-sensor 116 can sense a gravity direction, the G-sensor 116 is arranged in the display housing 112 in this embodiment. When the display housing 112 rotates with respect to the main housing 118, the G-sensor 116 can sense a change of the gravity direction, thereby allowing the main unit to judge whether the display is folded over the main unit after internal processing.

Referring to FIG. 1A, the main housing 118 of the portable computer 100 is placed on the horizontal plane 122 on which the main housing 118 is located, and the horizontal plane 122 is perpendicular to the gravity direction A. When the portable computer 100 is closed (i.e. the display housing 112 is folded over the main housing 120); and the G-sensor 116 is also horizontal to the horizontal plane 122 and disposed in the display housing 112, a gravity direction sensed by the G-sensor 116 is parallel to the gravity direction A, i.e. perpendicular to the horizontal plane 122. When the display housing 112 of the portable computer 100 rotates with respect to the main housing 118, the G-sensor 116 senses a change of the gravity direction.

Accordingly, when the G-sensor 116 of the present invention senses a gravity direction that is about 80° to 100° with respect to the main housing horizontal plane 122, the main board 120 receives the gravity direction sensed by the G-sensor 116 and triggers the processor 121 to turn off the display screen of the display 114. In addition, the portable computer 100 can be controlled to enter a power saving mode to save power. After the power saving mode is entered or the display screen of the display 114 is dimmed, when the gravity direction sensed by the G-sensor 116 is beyond a range of about 80° to 100° with respect to the horizontal plane 122 of the main housing 118, the processor 121 is triggered again to wake up the portable computer 100.

Next, referring to FIG. 1C, FIG. 1C is a system control flow chart for a portable computer according to an embodiment of the present invention. In step 124, a G-sensor senses a gravity direction. Then, in step 126, when the G-sensor senses a specific gravity direction, a signal is sent to a main board. Thereafter, in step 128, a processor on the main board controls a display to be turned off or enter a power saving mode.

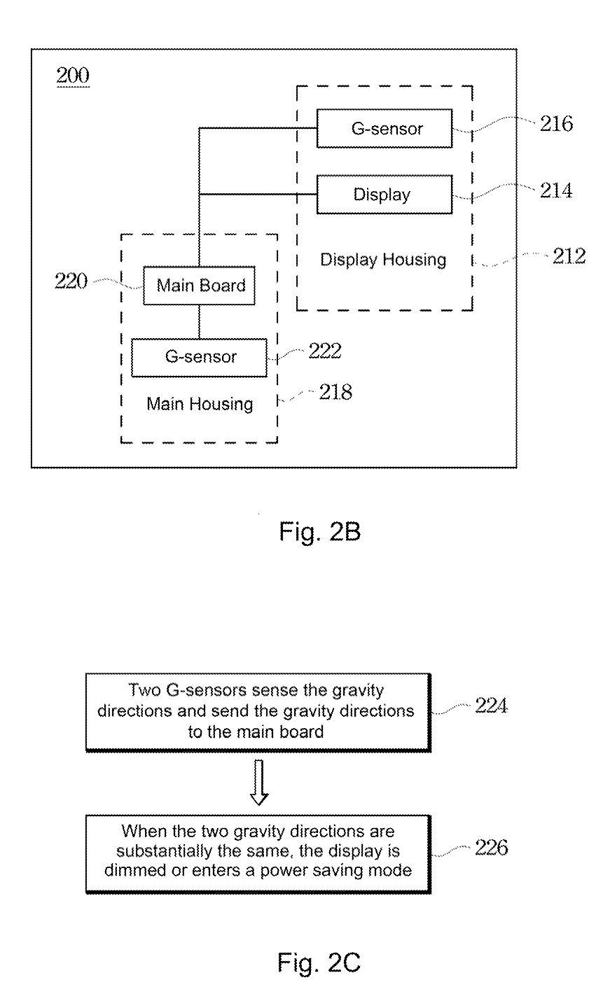

Next, referring to FIGS. 2A and 2B, FIG. 2A is a schematic view of a portable computer according to another embodiment of the present invention, and FIG. 2B is a system architecture view of a portable computer according to another embodiment of the present invention.

The portable computer 200 comprises a display housing 212, a first G-sensor 216, a main housing 218, a main board 220 and a second G-sensor 222. A display 214 is disposed inside the display housing 212. The first G-sensor 216 is arranged in the display housing 212. Moreover, the main housing 218 is pivotally connected to the display housing 212, so that the display housing 212 can be folded down to cover the main housing 218 to protect a display surface of the display 214; or the display housing 212 is approximately perpendicular to the main housing 218 for a user to use the portable computer 200 conveniently. The processor 221 is arranged on the main board 220. The main board 220 is arranged in the main housing 218, and is coupled to the G-sensor 216 and the display 214. Furthermore, in this embodiment, the second G-sensor 222 is also arranged in the main housing 218, and the second G-sensor 222 is coupled to the main board 220. As such, the portable computer 200 can identify more accurately whether the display is folded over the main unit through changes in gravity directions respectively sensed by the first G-sensor 216 and the second G-sensor 222.

When the portable computer 200 is closed and the first G-sensor 216 and the second G-sensor 222 are arranged in parallel, the gravity direction sensed by the G-sensor 216 is substantially parallel to the gravity direction sensed by the G-sensor 222. In this case, the two G-sensors 216 and 222 transfer the sensed gravity direction information to the main board 220, so as to trigger the processor 221 to turn off a display screen of the display 214 or enter a power saving mode. In order to fit a user better and improve user convenience, it can be configured that, when the difference between the gravity direction sensed by the first G-sensor 216 and the gravity direction sensed by the second G-sensor 222 is about 0° to 20°, the processor 221 is triggered to turn off the display 214, and to control the portable computer 200 to enter a power saving mode.

Next, referring to FIG. 2C, FIG. 2C is a system control flow chart for the portable computer of the above embodiment. In step 224, the two G-sensors sense gravity directions and send the sensed gravity directions to the main board. In step 226, when the two gravity directions are substantially the same (e.g. when the difference between the gravity directions is about 0° to 20°), the display is turned off or enters a power saving mode.

Moreover, in some portable computers, a pivoting structure between a display housing and a main housing may be particularly designed, so that the display housing still can be folded down to cover the main housing after being rotated by 180° when the portable computer is opened. In this way, such portable computers can be used as tablet computers, thereby enhancing the use flexibility of the portable computers.

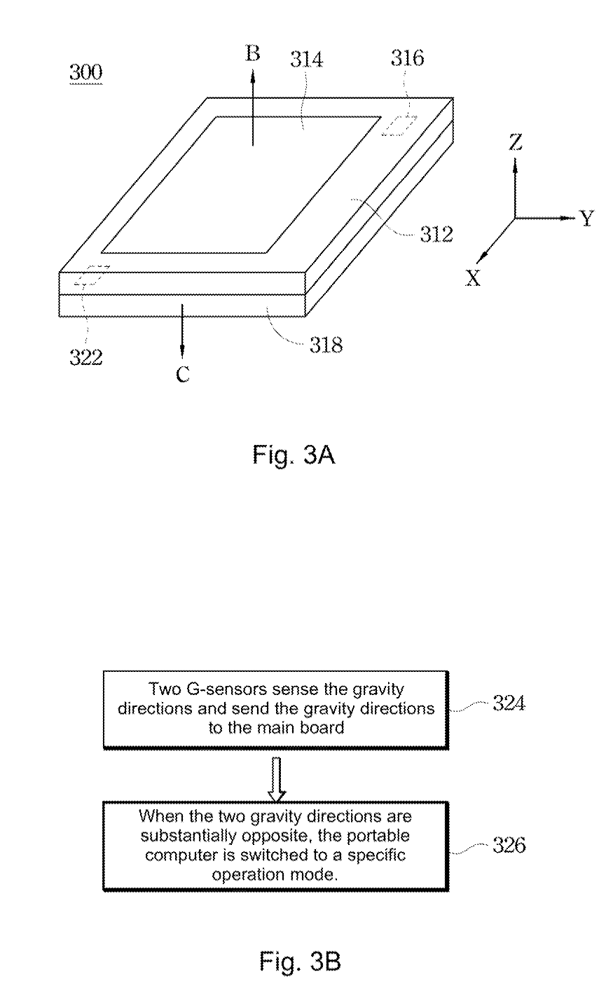

Referring to FIG. 3A, a first G-sensor 316 and a second G-sensor 322 of the portable computer 300 have the same arrangements as those of the portable computer 200 shown in FIG. 2A. However, the portable computer 300 as shown in FIG. 3A is in a state in which a display housing 312 is folded to cover a main housing 318 after being rotated by 180° when the portable computer 300 is opened. Therefore, compared with the portable computer 200 shown in FIG. 2A, the gravity directions sensed by the two G-sensors 316 and 322 are substantially opposite to each other. In this case, the two G-sensors 316 and 322 transfer the sensed gravity direction information to the main board, so as to trigger a processor to switch the portable computer 300 to a specific operation mode, e.g. a tablet computer operation mode. In order to fit a user better and improve user convenience, it can be configured that, when the difference between the direction sensed by the first G-sensor 316 and the direction sensed by the second G-sensor 322 is about 160° to 180°, the processor is triggered to switch the portable computer 300 to a specific operation mode, e.g. a tablet computer operation mode.

Next, referring to FIG. 3B, FIG. 3B is a system control flow chart for the portable computer of the above embodiment. In step 324, the two G-sensors sense the gravity directions and send the gravity directions to the main board. In step 326, when the two gravity directions are substantially opposite to each other (e.g. when the difference between the gravity directions is about 160° to 180°), the portable computer is switched to a specific operation mode, e.g. a tablet computer operation mode.

Moreover, after calculation, the gravity directions sensed by the G-sensors may also define the normal vector of the display surface of the display housing and the normal vector of the bottom surface of the main housing, thereby inferring the relative positions of the display and the main unit by using the two normal vectors.

Referring to FIG. 2A, the normal vector B of the display surface of the display housing can be defined through the gravity direction sensed by the first G-sensor 216 after calculation, and the second. G-sensor 222 can define the normal vector C of the bottom surface of the main housing. When the display 214 is folded to cover the main unit, it can be reckoned that both the normal vectors B and C are parallel to the minus Z axis. Thus, the system can be configured to control the portable computer 200 to enter a first operation mode when the difference between the normal vectors B and C is about 0° to 20°. In this embodiment, the first operation mode may be to turn off the display screen of the display or may be a power saving mode.

Next, referring to FIG. 3A, according to the normal vector defining manner of FIG. 2A, when the portable computer 300 is in a state in which the display housing 312 is folded to cover the main housing 318 after being rotated by 180° when the portable computer 300 is opened, it can be reckoned that the normal vectors B and C are parallel to the Z axis but in opposite directions. Thus, the system can be set to control the portable computer 300 to enter a second operation mode when the difference between the normal vectors B and C is about 160° to 180°. In this embodiment, as to the second operation mode, the portable computer 300 may be switched to a tablet computer operation mode.

Of course, since the normal vectors of this embodiment are reckoned through the data sensed by the G-sensors, the directions of the normal vectors are not specifically limited, and designers can make modifications according to practical uses.

The embodiments of the present invention arrange a G-sensor in a portable computer, which is used to sense a position of the display for judging whether the display covers the main unit and determining whether to turn off the display to enter a power saving mode. In this way, an accuracy of the portable computer to judge whether the display is folded to cover the main unit is improved and thus convenience of the portable computer in use is enhanced.

Although the present invention has been described with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A portable computer, comprising:
a display housing having a display arranged therein;
a first G-sensor arranged in the display housing;
a main housing pivotally connected to the display housing; and
a main board having a processor, wherein the main board is arranged in the main housing and is coupled to the first G-sensor and the display.

2. The portable computer of claim 1, wherein, when the gravity direction sensed by the first G-sensor is 80° to 100° with respect to the horizontal plane, the processor turns off the display.

3. The portable computer of claim 1, wherein, when the gravity direction sensed by the first G-sensor is 80° to 100° with respect to the horizontal plane, the processor controls the portable computer to enter a power saving mode.

4. The portable computer of claim 1, further comprising a second G-sensor arranged in the main housing and coupled to the main board.

5. The portable computer of claim 4, wherein, when the gravity direction sensed by the first G-sensor and the gravity direction sensed by the second G-sensor are substantially the same, the processor turns off the display.

6. The portable computer of claim 4, wherein, when the gravity direction sensed by the first G-sensor and the gravity direction sensed by the second G-sensor are substantially the same, the processor controls the portable computer to enter a power saving mode.

7. The portable computer of claim 4, wherein, when the difference between the gravity direction sensed by the first G-sensor and the gravity direction sensed by the second G-sensor is 0° to 20°, the processor turns off the display.

8. The portable computer of claim 4, wherein, when the difference between the gravity direction sensed by the first G-sensor and the gravity direction sensed by the second G-sensor is 0° to 20°, the processor controls the portable computer to enter a power saving mode.

9. The portable computer of claim 4, wherein, when the gravity direction sensed by the first G-sensor and the gravity direction sensed by the second G-sensor are substantially opposite to each other, the processor switches the portable computer to a specific operation mode.

10. The portable computer of claim 9, wherein the specific operation mode is a tablet computer operation mode.

11. The portable computer of claim 4, wherein, when the difference between the gravity direction sensed by the first G-sensor and the gravity direction sensed by the second G-sensor is 160° to 180°, the processor switches the portable computer to a specific operation mode.

12. The portable computer of claim 11, wherein the specific operation mode is a tablet computer operation mode.

13. A portable computer, comprising:
a display housing having a display arranged therein;
a first G-sensor arranged in the display housing;
a main housing pivotally connected to the display housing;
a second G-sensor arranged in the main housing; and
a main board having a processor, wherein the main board is arranged in the main housing, and is coupled to the first G-sensor, the second G-sensor and the display;
wherein, when the difference between the normal vector of the display surface of the display housing detected by the first G-sensor and the normal vector of the bottom surface of the main housing detected by the second G-sensor is 0° to 20°, the portable computer is controlled to enter a first operation mode.

14. The portable computer of claim 13, wherein the first operation mode is a power saving mode.

15. The portable computer of claim 13, wherein, when the difference between the normal vector of the display surface of the display housing detected by the first G-sensor and the normal vector of the bottom surface of the main housing detected by the second G-sensor is 160° to 180°, the processor switches the portable computer to a second operation mode.

16. The portable computer of claim 15, wherein the second operation mode is a tablet computer operation mode.

17. A portable computer, comprising:
a display housing having a display arranged therein;
a first G-sensor arranged in the display housing;
a main housing pivotally connected to the display housing;
a second G-sensor arranged in the main housing; and
a main board having a processor, wherein the main board is arranged in the main housing, and is coupled to the first G-sensor, the second G-sensor and the display;
wherein, when the normal vector of the display surface of the display housing detected by the first G-sensor and the normal vector of the bottom surface of the main housing detected by the second G-sensor are in the same directions, the portable computer is controlled to enter a first operation mode.

18. The portable computer of claim 17, wherein the first operation mode is a power saving mode.

19. The portable computer of claim 17, wherein when the normal vector of the display surface of the display housing detected by the first G-sensor and the normal vector of the bottom surface of the main housing detected by the second G-sensor are in opposite directions, the processor switches the portable computer to a second operation mode.

20. The portable computer of claim 19, wherein the second operation mode is a tablet computer operation mode.
